(19) United States
(12) Patent Application Publication
(10) Pub. No.: US 2013/0325577 A1
(43) Pub. Date: Dec. 5, 2013

(54) COMMUNICATION SYSTEM WITH CUSTOMER LOYALTY DATABASE AND RELATED METHODS

(71) Applicants: Gary BONNER, Oviedo, FL (US); Leslie BONNER, Oviedo, FL (US)

(72) Inventors: Gary BONNER, Oviedo, FL (US); Leslie BONNER, Oviedo, FL (US)

(21) Appl. No.: 13/891,293

(22) Filed: May 10, 2013

Related U.S. Application Data
(60) Provisional application No. 61/645,920, filed on May 11, 2012.

(51) Int. Cl. G06Q 30/02

(52) U.S. Cl. CPC G06Q 30/0226
USPC 705/14.27

(57) ABSTRACT

A communication system may include a mobile wireless communications device, and a server communicating with the mobile wireless communications device and storing a customer loyalty database including customer loyalty records for corresponding users. The customer loyalty records may include a respective customer loyalty record associated with a user of the mobile wireless communications device. The mobile wireless communications device may access the server via a web page interface, input, via the web interface, identification data associated with the respective customer loyalty record for logging into the server, send a vendor use code to the server, and selectively cause the server to update the respective customer loyalty record based upon the vendor use code provided to the server via the web interface.

### RELATED APPLICATIONS

This application is based upon prior filed copending provisional patent application Ser. No. 61/645,920 filed May 11, 2012, the entire subject matter of which is incorporated herein by reference in its entirety.

### FIELD OF THE INVENTION

The present invention relates to the field of mobile wireless communications devices, and, more particularly, to mobile wireless communications device software and related methods.

### BACKGROUND OF THE INVENTION

For any business, the act of marketing is an important and critical operation. Indeed, if a business does not market well, the business is more likely to fail. There are several very common methods of marketing, for example, advertising and telephone marketing (i.e. cold calls). Once particular type of marketing is a customer loyalty program.

The loyalty program is a structured marketing effort that rewards, and therefore encourages, loyal buying behavior. More specifically, the business maintains a record of the customer's past buying activities and provides varying future services (e.g. discounts, promotions) based upon that record. In marketing generally and in retailing more specifically, a loyalty card, rewards card, points card, advantage card, or club card is a plastic or paper card, visually similar to a credit card or debit card, that identifies the card holder as a member in a loyalty program.

Accordingly, when the loyalty program customer frequents a business, the customer carries the loyalty card and presents it each time to update the record with the current purchase. In the field of food services industry, the typical customer loyalty program provides the customer with a complimentary meal after the regular purchase of a set number of meals. Most commonly, the business issues the customer a paper card, which is punched by an employee each time the customer frequents the business.

A drawback to this approach is that the customer must now carry the card with them regularly or properly anticipate visits to the business. There is also tremendous waste of resources as regular customers generate respective collections of “one-punch” cards. Additionally, the user may also lose the loyalty card and the record of the prior purchases. Moreover, this punch card approach may be problematic for the business also since the punch card may be fraudulently punched, thereby getting a “free lunch.”

An approach to these drawbacks may comprise replacing the typical paper loyalty card with a plastic magnetic strip card. Again, this approach requires the user to carry yet another plastic card with them. Also, the magnetic strip card requires the business to deploy expensive magnetic strip card readers and writers to operate the customer loyalty program.

### SUMMARY OF THE INVENTION

In view of the foregoing background, it is therefore an object of the present invention to provide a communication system that operates a customer loyalty program more efficiently.

This and other objects, features, and advantages in accordance with the present invention are provided by a communication system comprising at least one mobile wireless communications device, and a server communicating with the at least one mobile wireless communications device and storing a customer loyalty database including a plurality of customer loyalty records for a corresponding plurality of users. The plurality of customer loyalty records comprises a respective customer loyalty record associated with a user of the at least one mobile wireless communications device. The at least one mobile wireless communications device accesses the server via a web page interface, inputs, via the web interface, identification data associated with the respective customer loyalty record for logging into the server, sends a vendor use code to the server, and selectively causes the server to update the respective customer loyalty record based upon the vendor use code provided to the server via the web interface. Advantageously, the server may more readily operate with feature phones.

In some embodiments, the server may generate the web interface comprising a desired protocol, and the server may select the desired protocol based upon at least one performance characteristic of the at least one mobile wireless communications device. Also, the at least one mobile wireless communications device may send the vendor use code to the server via the web interface, or send the vendor use code to the server via a short message service (SMS) message.

The server may generate a digital customer loyalty card in the web interface. The digital customer loyalty card may be associated with a vendor of the vendor use code. The server may generate the web interface to comprise a tiled interface comprising a plurality of digital customer loyalty cards for the respective customer loyalty record.

Additionally, the server may update the respective customer loyalty record based upon the vendor use code comprising a purchase activity quality value. The communication system may further comprise a point of sale (POS) device providing the vendor user code to the at least one mobile wireless communications device. For example, the identification data may comprise a user id and user password.

Another aspect is directed to a method of operating a communication system. The method comprises using a server to communicate with at least one mobile wireless communications device and to store a customer loyalty database including a plurality of customer loyalty records for a corresponding plurality of users. The plurality of customer loyalty records comprises a respective customer loyalty record associated with a user of the at least one mobile wireless communications device. The method includes using the at least one mobile wireless communications device to access the server via a web page interface, input, via the web interface, identification data associated with the respective customer loyalty record for logging into the server, send a vendor use code to the server, and selectively cause the server to update the respective customer loyalty record based upon the vendor use code provided to the server via the web interface.

### BRIEF DESCRIPTION OF THE DRAWINGS

FIG. 1 is a schematic diagram of a communication system, according to the present invention.

FIG. 2 is a flowchart illustrating operation of an example embodiment of the communication system of FIG. 1.

FIG. 3 is a flowchart illustrating operation of an example embodiment of the communication system of FIG. 1.

FIG. 4 is a flowchart illustrating operation of an example embodiment of the communication system of FIG. 1.

FIG. 5 is a flowchart illustrating operation of an example embodiment of the communication system of FIG. 1.

FIGS. 6-8 are screenshots from the mobile wireless communications device in an example embodiment of the communication system, according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

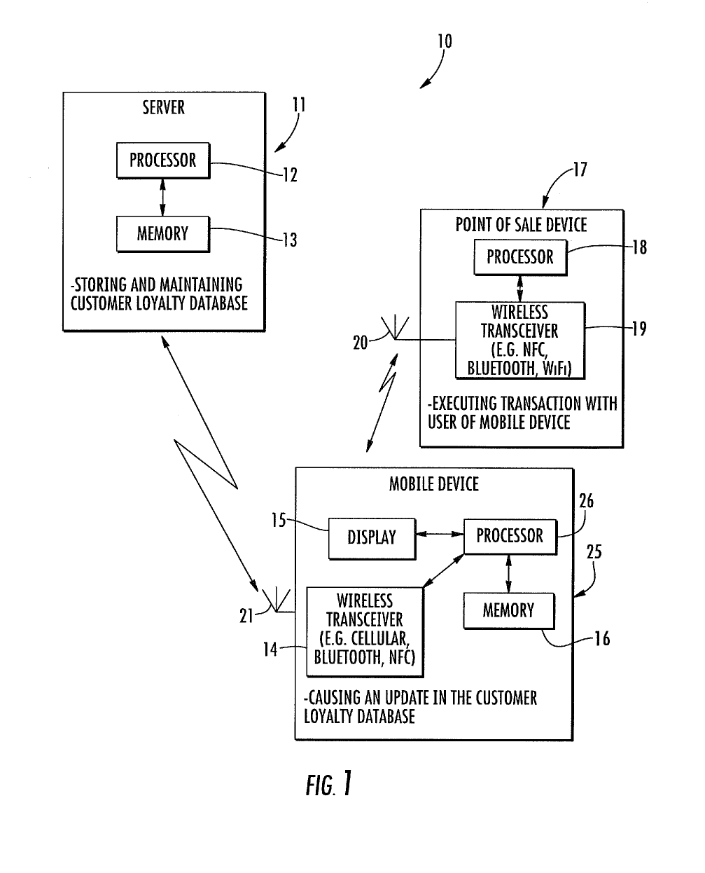

Referring initially to FIG. 1, a communication system 10 according to the present invention is now described. The communication system 10 illustratively includes a mobile wireless communications device 25, a server 11 communicating with the mobile wireless communications device, and a point of sale (POS) device 17 communicating with the mobile wireless communications device. For example, the POS device 17 may be permanently located at a retail counter and operated by sales personnel. In other embodiments, the POS device 17 may comprise a handheld computing device, such as a tablet computer.

The server 11 illustratively includes a processor 12, and a memory 13 cooperating therewith. The server 11 may be coupled to the mobile wireless communications device 25 via a communication network (e.g. Internet). The POS device 17 illustratively includes a processor 18, a wireless transceiver 19 (e.g. one or more of near field communications (NFC), Bluetooth, infrared, cellular, or WiFi transceivers) coupled thereto, and an antenna 20 coupled to the wireless transceiver. The mobile wireless communications device 25 illustratively includes a processor 26, a display 15 (e.g. LCD, OLED, LED) coupled to the processor, a wireless transceiver 14 (e.g. one or more of cellular, WiFi, Bluetooth, NFC transceivers) coupled to the processor, a memory 16 coupled to the processor, and an antenna 21 coupled to the wireless transceiver.

The server 11 stores a customer loyalty database including a plurality of customer loyalty records. For example, each customer loyalty record includes user name and password (login credentials), an email address, associated vendor businesses (e.g. restaurants and retail stores participating in the loyalty program supported by the database), available customer loyalty rewards, and redeemed customer loyalty rewards. Of course, the plurality of customer loyalty records comprises a respective customer loyalty record associated with a user of the mobile wireless communications device 25. During use, the user will frequent a vendor business and make a purchase. In prior art approaches, the user would present a card (paper or magnetic strip type) to the vendor for recording the purchase (i.e. punching the card or reading the magnetic strip). In the approach of the present disclosure, the mobile wireless communications device 25 selectively causes the server 11 to update the respective customer loyalty record based upon this user activity, i.e. purchase. In particular, the processor 26 presents the user with a visual representation of the respective customer loyalty record on the display 15, i.e. a digital customer loyalty card (FIG. 8).

The process of causing the server 11 to update the respective customer loyalty record may be accomplished via several methods. In one embodiment, the vendor business may present the user with a special code (e.g. a numeric code, bar code, Quick Response (QR) code) for entering and transmission to the server via the mobile wireless communications device 25. For the bar/QR code embodiments, the mobile wireless communications device 25 includes a camera (not shown), and the processor cooperates with the camera to scan and transmit the appropriate code to the server 11. Once the server 11 validates the code (e.g. by comparing the code to stored verified codes in the memory 13), the server updates the respective customer loyalty record. In advantageous embodiments, the code includes encoded information about the quality or amount of the customer purchase, thereby enabling the server 11 to more accurately update the respective customer loyalty record. In some embodiments, the POS device 17 may be omitted, i.e. the mobile wireless communications device 25 directly communicates with the server 11. For example, the vendor business may manually provide a code for scanning by/entering into the mobile wireless communications device 25. For example, the vendor business may present a placard with a QR code for the user to scan with the mobile wireless communications device 25.

In another embodiment, the mobile wireless communications device 25 may present a QR code on its display for reading by the POS device 17, which would then communicate with the server 11 to cause the update of the respective customer loyalty record. In these embodiments, the POS device 17 includes a camera (not shown), and communicates with the server 11 over a network (e.g. Internet). In yet another embodiment, the mobile wireless communications device 25 and the POS device 17 may communicate via Bluetooth or WiFi communications.

In yet another embodiment, the mobile wireless communications device 25 and the POS device 17 may exchange the same information over a NFC link. In other words, the user would bump the mobile wireless communications device 25 with the NFC transceiver 19 of the POS device 17. After this bump, the server 11 would update the respective customer loyalty record of the user automatically (either the mobile wireless communications device 25 or the POS device 17 would contact the server 11).

Also, in the illustrated embodiment, the server 11 is communicating with the mobile wireless communications device 25 and the POS device 17 over the Internet and can be remotely located. In other embodiments, the server 11 may be locally located at the vendor business and may maintain only the customer loyalty program of that particular vendor business.

Of course, the Internet remotely located embodiments of the server 11 are quite adept at serving a plurality of vendor business located anywhere (i.e. providing the user with a universal customer loyalty card). In these embodiments, the user no longer maintains a plurality of customer loyalty cards as each is digitally maintained in the customer loyalty database. Indeed, the vendor businesses may directly interface with the server 11 to modify the customer loyalty program and contact participants.

For example, the universal loyalty card may be associated with vendor businesses of a merchant association. In some embodiments, the server 11 may maintain multiple association customer records for the respective user. In yet other embodiments, the respective customer loyalty record includes brand specific purchase information, thereby enabling brand specific customer loyalty programs that span multiple vendor businesses.

In the illustrated embodiment, the customer loyalty database is stored and maintained on the server 11. Nonetheless, in other embodiments, the mobile wireless communications device 25 may maintain and update the database on board. In these embodiments, the database would only contain the single customer loyalty record of the user, and the POS device 17 would access this database for updating the customer loyalty record with the current purchase. Advantageously, the mobile wireless communications device 25 may even encrypt the customer loyalty database to reduce risk of user manipulation and/or fraud. Indeed, in some embodiments, the user may access the database by launching a mobile application (e.g. native application in Apple IOS, Google Android, or Blackberry 10).

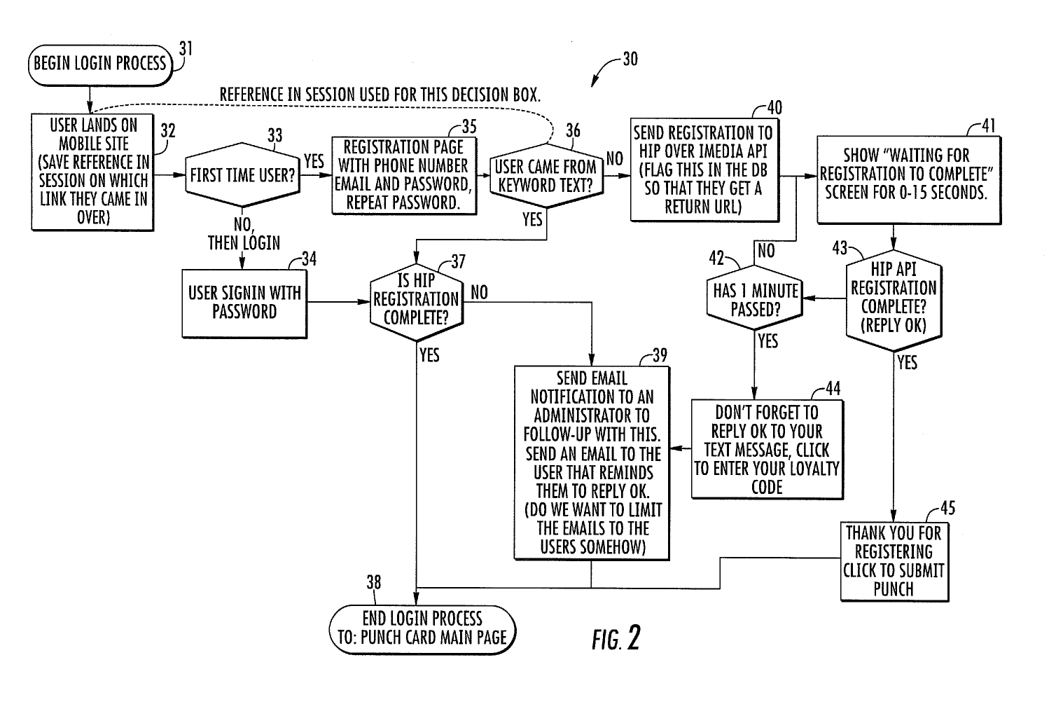

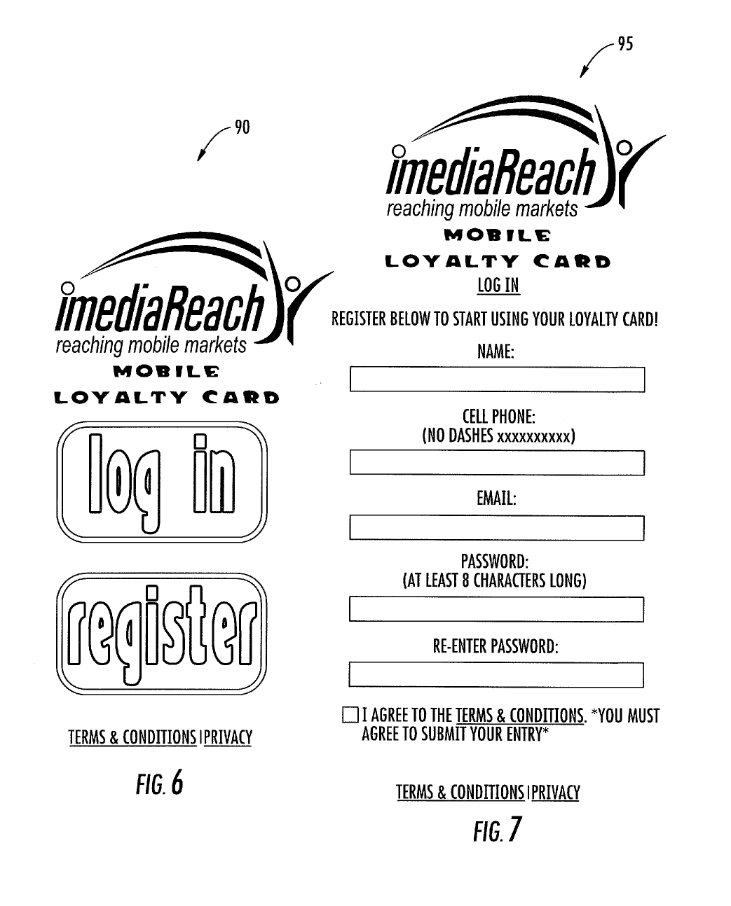

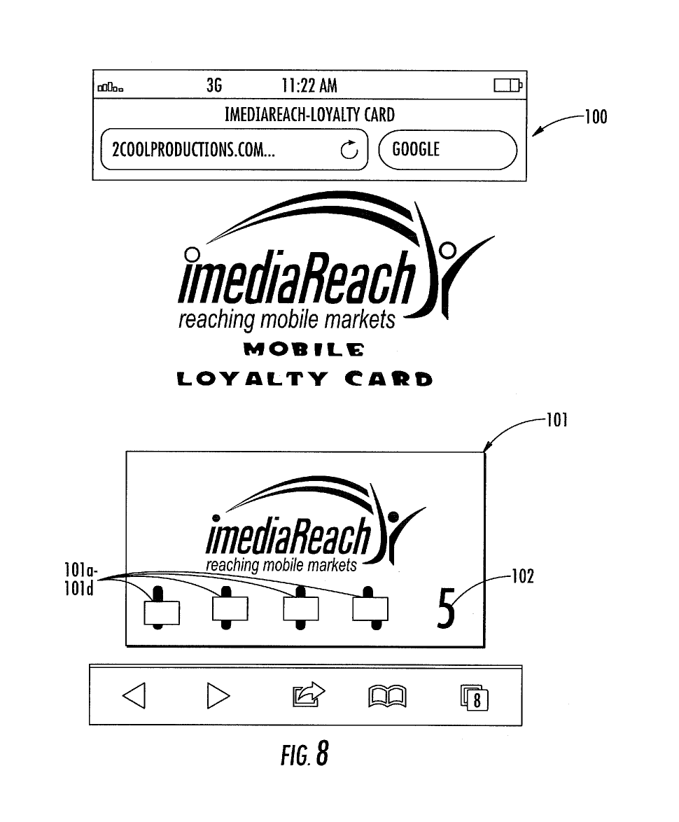

Referring now additionally to FIGS. 2-8, an example embodiment of the communication system 10 is now described. In this example embodiment, the server 11 maintains the customer loyalty database and communicates directly with the mobile wireless communications device 25 over the Internet (POS device 17 omitted). The user accesses the customer loyalty database via the mobile web browser of the mobile wireless communications device 25 communicating with the server 11.

As shown in FIG. 2, a flowchart 30 illustrates operation of the mobile wireless communications device 25 communicating with the server 11. In particular, along with a screenshot 90, the login and authentication of the user is performed (Blocks 31-45). Also, screenshot 95 shows a process for registering a new user. Once the user is successfully registered, the server 11 confirms registration via confirmation SMS messages.

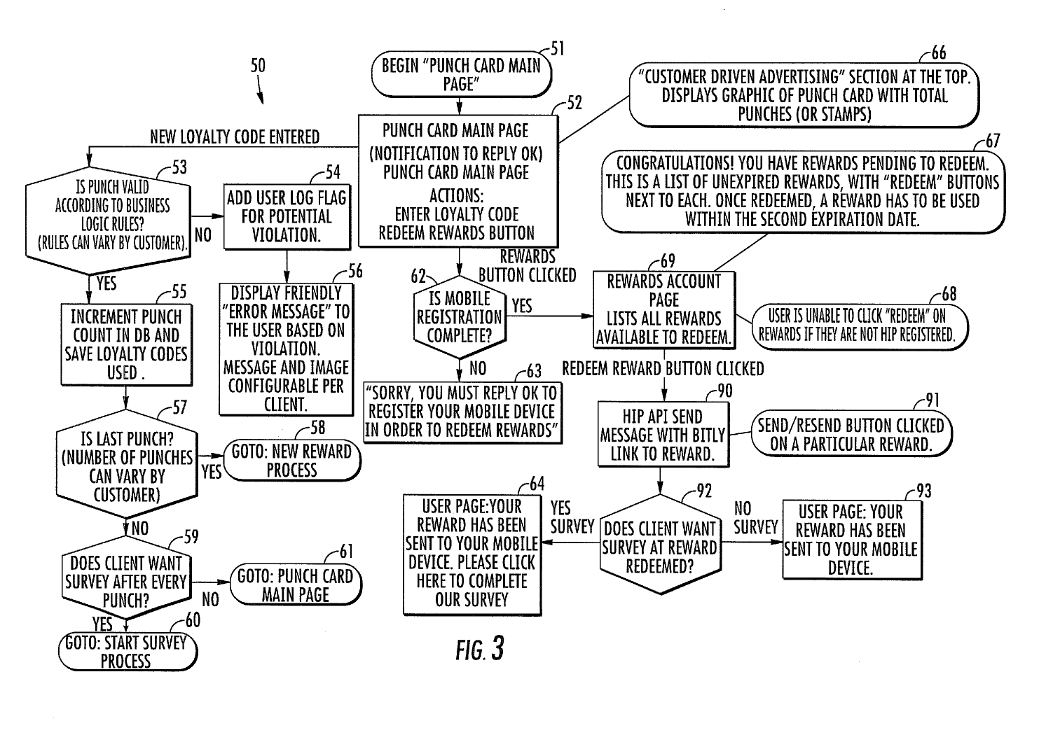

In FIG. 3, flowchart 50 illustrates the logic of the server 11. Blocks 51-61 include steps for the user at the mobile wireless communications device 25 for redeeming a new loyalty code. Blocks 62-64, 66-69, & 90-93 include steps for presenting the user with all available rewards and options for the redemption thereof.

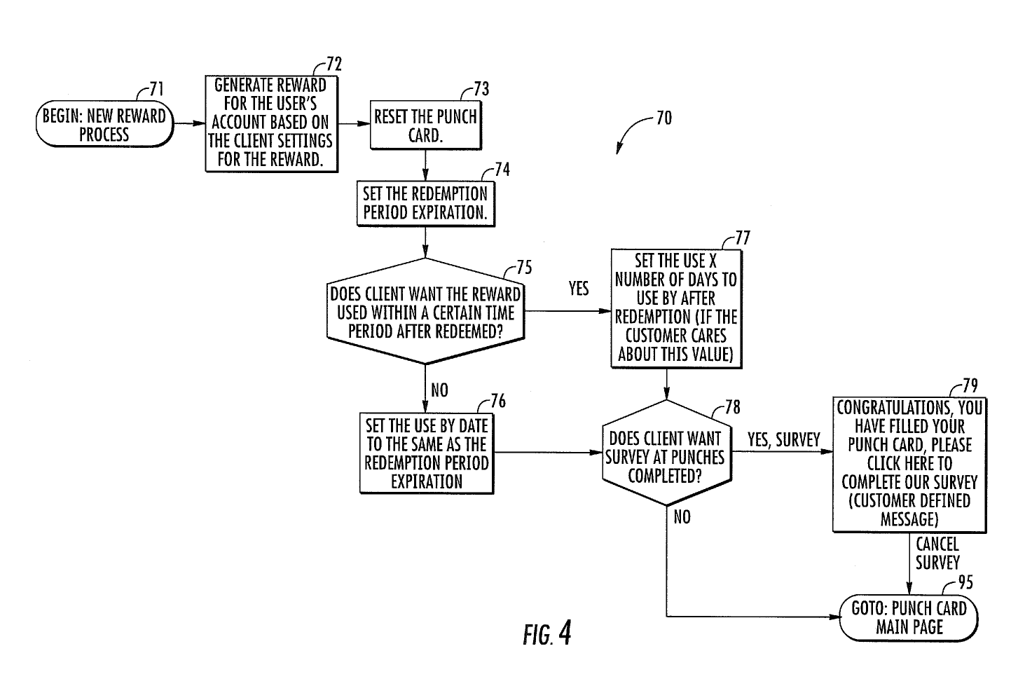

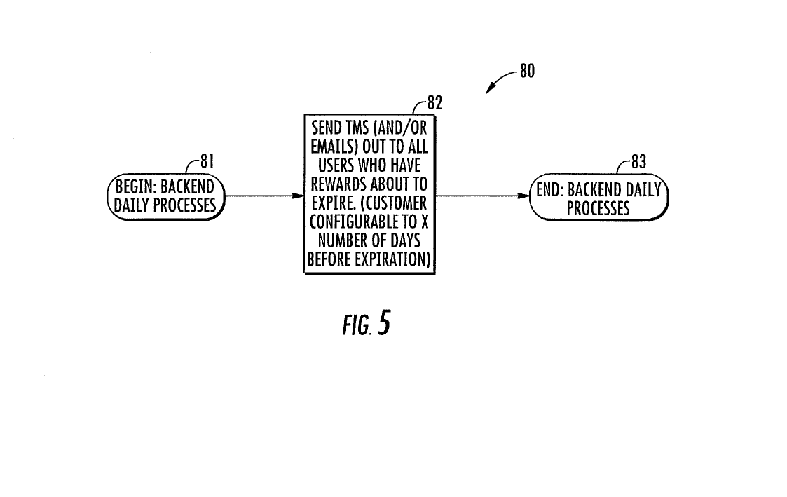

In FIGS. 4-5, flowchart 70 illustrates additional logic of the server 11. Blocks 71-79, 95 include steps for generating the reward for the user based upon vendor requirements. It should be noted that a reward may be added to the reward page (UserReward) based upon the client/store rules at the time and RESET the punch card. The client rules also determine the life of that reward (expiration based on time out or date specific, or the number of times of usage, even unlimited during a window). Flowchart 80 illustrates additional logic of the server 11. Blocks 81-83 include steps for generating alerts sent from the server 11 to the mobile wireless communications device 25.

Once the user is logged in, as shown in screenshot 100, the mobile wireless communications device 25 presents the user with a digital customer loyalty card 101, which is a visual representation of at least a part of the data in the respective customer loyalty record. The digital customer loyalty card 101 illustratively includes a plurality of “punches” 101a-101d for indicating prior user purchases, and a space 102 for future purchases. In advantageous embodiments, the user is first presented with a tiled interface comprising each of the user's digital customer loyalty cards for varying vendor businesses. Once the user selects a tile, the detailed digital customer loyalty card 101 is presented.

In particular, flowchart 80 illustrates the operation of the server 11 reminding users via messaging (e.g. email, SMS) that they have rewards that may expire soon. Indeed, the server 11 may notify with the users when rewards are earned, expired, and/or changed.

Additionally, this illustrated embodiment has the added advantage of being platform independent since it may be accessed via a typical web browser. Indeed, the interface to the server 11 is provided in HTML5. As will be appreciated by those skilled in the art, many mobile devices across varying providers and platforms provide a HTML5 compliant web browser.

In yet another advantageous embodiment, the communication system 10 may be configured to better serve “feature” phones, i.e. non-smart phones. In particular, the POS device 17 is again omitted in these embodiments and the mobile wireless communications device 25 and the server 11 communicate directly over the Internet and/or SMS messages. In some embodiments, the server 11 and the mobile wireless communications device 25 may communicate purely using SMS messages. For example, the user may be presented with a special code to send to the server 11 via SMS. The server 11 identifies the user via the incoming telephone number and updates the respective customer loyalty record.

In yet another embodiment, the server 11 selectively communicates with each mobile wireless communications device 25 based upon the respective capabilities of the device. For example, for smartphones, the server 11 would communicate via the full web browser, i.e. HTML 5, interface or a native application. Confirmations messages would be sent via email, for example. For feature phones, the server 11 would communicate using a Wireless Application Protocol (WAP) browser interface and/or SMS messages. In short, the server 11 would provide multiple technological tiers of interface, thereby potentially serving a greater number of customers.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communication system comprising:
at least one mobile wireless communications device; and
a server communicating with said at least one mobile wireless communications device and storing a customer loyalty database including a plurality of customer loyalty records for a corresponding plurality of users;
said plurality of customer loyalty records comprising a respective customer loyalty record associated with a user of said at least one mobile wireless communications device;
said at least one mobile wireless communications device
accessing said server via a web page interface,
inputting, via the web interface, identification data associated with the respective customer loyalty record for logging into said server,
sending a vendor use code to said server, and
selectively causing said server to update the respective customer loyalty record based upon the vendor use code provided to said server via the web interface.

2. The communication system of claim 1 wherein said server generates the web interface comprising a desired protocol; and wherein said server selects the desired protocol based upon at least one performance characteristic of said at least one mobile wireless communications device.

3. The communication system of claim 1 wherein said at least one mobile wireless communications device sends the vendor use code to said server via the web interface.

4. The communication system of claim 1 wherein said at least one mobile wireless communications device sends the vendor use code to said server via a short message service (SMS) message.

5. The communication system of claim 1 wherein said server generates a digital customer loyalty card in the web interface, the digital customer loyalty card being associated with a vendor of the vendor use code.

6. The communication system of claim 1 wherein said server generates the web interface to comprise a tiled interface comprising a plurality of digital customer loyalty cards for the respective customer loyalty record.

7. The communication system of claim 1 wherein said server updates the respective customer loyalty record based upon the vendor use code comprising a purchase activity quality value.

8. The communication system of claim 1 further comprising a point of sale (POS) device providing the vendor user code to said at least one mobile wireless communications device.

9. The communication system of claim 1 wherein the identification data comprises a user id and user password.

10. A mobile wireless communications device communicating with a server storing a customer loyalty database including a plurality of customer loyalty records for a corresponding plurality of users, the plurality of customer loyalty records comprising a respective customer loyalty record associated with a user, the mobile wireless communications device comprising:
a memory;
a display;
processor coupled to said memory and said display and
accessing the server via a web page interface on said display,
inputting, via the web interface, identification data associated with the respective customer loyalty record for logging into the server,
sending a vendor use code to the server, and
selectively causing the server to update the respective customer loyalty record based upon the vendor use code provided to the server via the web interface.

11. The mobile wireless communications device of claim 10 wherein said processor sends the vendor use code to the server via the web interface.

12. The mobile wireless communications device of claim 10 wherein said processor sends the vendor use code to the server via a short message service (SMS) message.

13. The mobile wireless communications device of claim 10 wherein said processor cooperates with the server to provide a digital customer loyalty card in the web interface, the digital customer loyalty card being associated with a vendor of the vendor use code.

14. The mobile wireless communications device of claim 10 wherein said processor cooperates with the server to generate the web interface to comprise a tiled interface comprising a plurality of digital customer loyalty cards for the respective customer loyalty record.

15. A method of operating a communication system, the method comprising:
using a server to communicate with at least one mobile wireless communications device and to store a customer loyalty database including a plurality of customer loyalty records for a corresponding plurality of users, the plurality of customer loyalty records comprising a respective customer loyalty record associated with a user of the at least one mobile wireless communications device; and
using the at least one mobile wireless communications device to
access the server via a web page interface,
input, via the web interface, identification data associated with the respective customer loyalty record for logging into the server,
send a vendor use code to the server, and
selectively cause the server to update the respective customer loyalty record based upon the vendor use code provided to the server via the web interface.

16. The method of claim 15 further comprising using the server to generate the web interface comprising a desired protocol, and to select the desired protocol based upon at least one performance characteristic of the at least one mobile wireless communications device.

17. The method of claim 15 further comprising using the at least one mobile wireless communications device to send the vendor use code to the server via the web interface.

18. The method of claim 15 further comprising using the at least one mobile wireless communications device send the vendor use code to the server via a short message service (SMS) message.

19. The method of claim 15 further comprising using the server to generate a digital customer loyalty card in the web interface, the digital customer loyalty card being associated with a vendor of the vendor use code.

20. The method of claim 15 further comprising using the server to generate the web interface to comprise a tiled interface comprising a plurality of digital customer loyalty cards for the respective customer loyalty record.
